(19) United States
(12) Patent Application Publication
(10) Pub. No.: US 2009/0154790 A1
(43) Pub. Date: Jun. 18, 2009

(54) Wiring Pattern Inspection Method and Inspection Apparatus for Flexible Printed Wiring Board

(75) Inventor: Tetsuyuki Narabayashi, Tokyo (JP)

Correspondence Address: THE WEBB LAW FIRM, P.C., 700 KOPPERS BUILDING, 436 SEVENTH AVENUE, PITTSBURGH, PA, 15219, US

(73) Assignee: MITSUI MINING & SMELTING CO., LTD., Tokyo (JP)

(21) Appl. No.: 12/302,510

(22) PCT Filed: Apr. 18, 2007
(86) PCT No.: PCT/JP2007/058468

§ 371 Date: Nov. 26, 2008

(30) Foreign Application Priority Data
May 30, 2006 (JP) 2006-150078

(51) Int. Cl. G06T 7/00

(52) U.S. Cl. 382/149

(57) ABSTRACT

In a method for inspecting a wiring pattern on a flexible printed wiring board, light is illuminated from a front surface side of the TAB tape T while a drum is provided on the rear surface side of the TAB tape T such that a reflection method becomes main and a transmission method becomes subordinate, and when imaging a wiring pattern image of an inspection part D on the front surface side, it becomes possible to determine the quality of a wiring pattern taking advantage of the reflection method. Furthers by utilizing the indirect transmission light, defects of a short-circuiting type on the light permeable insulating film that are difficult to be detected with the reflection method can be detected as darker defects than the light permeable insulating film by the transmission method.

### TECHNICAL FIELD

The present invention relates to a wiring pattern inspection method and an inspection apparatus for a flexible printed wiring board, in particular for a film carrier tape for mounting an electronic part.

### BACKGROUND ART

With development of the electronics industry, demands for a printed wiring board for mounting electronic parts such as an integrated circuit (IC) chip or a large scale integration (LSI) chip are rapidly increasing. Size reduction, weight reduction, and higher functions of electronic devices are demanded. As a method for mounting these electronic parts, a mounting method in which a flexible printed wiring board, for example a film carrier tape for mounting an electronic part such as a chip on film (COF) tape, a tape carrier package (TCP) tape, a tape ball grid array (BGA) tape, and an application specific integrated circuit (ASIC) tape (hereinafter, simply called a “film carrier tape” or a “tape automated bonding (TAB) tape”) or a flexible printed circuit (FPC) is employed recently.

As such a TAB tape, a film carrier tape in which a device hole is not formed on an insulating film, but a terminal for connection with a terminal of an electronic part is provided on a mounting surface of the insulating film is used recently. In this case, when a mounting board is incorporated to a module, the insulating film has to be thin in order for example to be bent at a given section. For this reason, conventionally, when manufacturing a COF tape, an adhesive layer is not formed on the surface of the extremely thin insulating film, but copper clad laminate (CCL) having a two-layer structure in which a conductive metal is deposited directly is used.

The CCL having the two-layer structure is formed by forming a seed layer made of nickel or the like by an evaporation method or a sputtering method onto the surface of the extremely thin insulating film such as a polyimide film, and then plating the seed layer with a conductive metal such as copper. A photoresist is coated onto the surface of the conductive metal layer of the CCL having the two-layer structure thus formed, the photoresist is developed after light-exposure into a desired pattern, the conductive metal layer is etched with the remaining photoresist hardened material as a masking material, and a desired wiring pattern is formed.

With the TAB tape such as a COF tape, it is necessary to inspect whether a wiring pattern is formed into a desired form, and conventionally a quality is inspected by checking line disconnection, short-circuiting, notch, and the like of the wiring pattern. Such a wiring pattern inspection is based on a determination of the quality of a wiring pattern by irradiating the TAB tape with illumination light, imaging the illuminated wiring pattern image by an imaging unit such as a charge coupled device (CCD) imaging sensor or the like, and comparing data of a master pattern image obtained in advance.

Two methods for imaging a wiring pattern image are known: a reflection method in which reflection light from a TAB tape is utilized and a transmission method in which transmission light transmitting through a TAB tape is utilized. In the reflection method, illumination light is emitted from a wiring pattern surface side of the TAB tape, and the wiring pattern image reflected from the surface side is imaged by an imaging unit. On the other hand, in the transmission method, because a light permeable insulating film such as polyimide is used as a base material of the TAB tape, illumination light is emitted from a rear surface side of the TAB tape, or a surface side on which the light permeable insulating film layer is formed opposite the surface on which a wiring pattern to be inspected is formed, and the wiring pattern image formed by transmitting light transmitting through the light permeable insulating film is imaged by an imaging unit (for example, see Patent Document 1).

However, the reflection method and the transmission method have advantages and disadvantages, and it is known that determination of the quality of a wiring pattern cannot be appropriately performed with either of the methods singly. In the reflection method, when the wiring pattern becomes finely pitched due to narrow lines and high densification, spaces between the wiring patterns become like bottoms of valleys, and even if there is short-circuiting between the wiring pitches, light is rarely reflected; therefore, the method is inferior in the ability to detect defects of short-circuiting, particularly short-circuiting on the surface of the light permeable insulating film.

On the other hand, in the transmission method, a bottom part of the wiring pattern is inspected, and the method has an advantage that it has a high ability to detect defects of short-circuiting; however, it has an disadvantage that defects on the surface side such as top notches cannot be detected because the surface state of the wiring pattern cannot be observed.

For these reasons, there is a method in which a quality of a wiring pattern is determined by a combination of the reflection method and the transmission method (for example, see Patent Document 2). That is, the quality of a wiring pattern is determined basically using transmission illumination by imaging by an imaging unit a transmission illumination image obtained by illuminating the TAB tape with transmission illumination means, and then imaging by an imaging unit a reflection illumination image obtained by illuminating with reflection illumination means, and the quality of the wiring pattern is determined utilizing reflection illumination for examining defects such as top notches not suited for the transmission method.

[Patent Document 1] Japanese Patent Application Laid-open No. 2003-303862

[Patent Document 2] Japanese Patent Application Laid-open No. 2005-140663

[Patent Document 3] Japanese Patent Application Laid-open No. H4-265846

[Patent Document 4] Japanese Patent Application Laid-open No. H4-286943

[Patent Document 5] Japanese Patent Application Laid-open No. H4-269612

### DISCLOSURE OF INVENTION

### Problem to be Solved by the Invention

In the method combining the transmission method and the reflection method disclosed in Patent Document 2, it is necessary to reciprocate an imaging optical system with the TAB tape resting temporarily at the same stage to obtain image data of the transmission system and the reflection system. Therefore, the measurement time doubles as compared with a single method.

By providing the transmission imaging optical system and the reflection imaging optical system on different stages, it is possible to obtain image data of the transmission system and the reflection system simultaneously, but this increases the size of the apparatus and increases the apparatus cost significantly.

The present invention has been made in view of the above circumstance, and is aimed at providing a wiring pattern inspection method and an inspection apparatus for a flexible printed wiring board that can detect the quality of a wiring pattern with a simple structure without increasing the measurement time, and without increasing the size and the cost of the inspection apparatus.

### Means for Solving Problem

In order to solve the problems and to attain the object, a wiring pattern inspection method for a flexible printed wiring board, which inspects a quality of a wiring pattern formed on a front surface of a light permeable insulating film according to the present invention includes: irradiating with illumination light an inspection part of the flexible printed wiring board from the front surface in a state where a reflection member whose surface is mirrored is disposed on a rear surface of the flexible printed wiring board; imaging a wiring pattern image formed by overlapping reflection light obtained from the inspection part on the front surface of the flexible printed wiring board, and indirect transmission light transmitted through the light permeable insulating film, reflected from the reflection member, and transmitted again through the light permeable insulating film; and examining the quality of the wiring pattern based on a wiring pattern image imaged by the imaging unit and formed by overlapping the reflection light and the indirect transmission light.

In the wiring pattern inspection method for a flexible printed wiring board according to the present invention, the reflection member is a drum whose surface is mirrored.

In the wiring pattern inspection method for a flexible printed wiring board according to the present invention, the imaging unit is a line sensor that is fixed at a position and is capable of imaging an entire width of the flexible printed wiring board, and the line sensor images a wiring pattern image of the inspection part successively while the inspection part is successively changed by carrying the flexible printed wiring board at a predetermined speed.

In the wiring pattern inspection method for a flexible printed wiring board according to the present invention, reddish illumination light is applied onto the flexible printed wiring board.

In the wiring pattern inspection method for a flexible printed wiring board according to the present invention, feeble scattered light is applied onto the inspection part of the front surface of the flexible printed wiring board in addition to the illumination light.

In the wiring pattern inspection method for a flexible printed wiring board according to the present invention, the flexible printed wiring board is a film carrier tape for mounting an electronic part.

In the wiring pattern inspection method for a flexible printed wiring board according to the present invention, the flexible printed wiring board is a COF tape in which the wiring pattern is directly formed on the light permeable insulating film.

An inspection apparatus for a flexible printed wiring board, which inspects a quality of a wiring pattern formed on a front surface of a light permeable insulating film according to the present invention includes: a reflection member whose surface is mirrored and which is disposed on a rear surface of the flexible printed wiring board; a light source that emits illumination light onto an inspection part of the flexible printed wiring board from the front surface; an imaging unit that images a wiring pattern image formed by overlapping reflection light obtained from the inspection part on the front surface of the flexible printed wiring board, and indirect transmission light transmitted through the light permeable insulating film, reflected from the reflection member, and transmitted again through the light permeable insulating film; and a determining unit that determines the quality of the wiring pattern based on a wiring pattern image imaged by the imaging unit formed by overlapping the reflection light and the indirect transmission light.

In the inspection apparatus for a flexible printed wiring board according to the present invention, the reflection member is a drum whose surface is mirrored.

The inspection apparatus for a flexible printed wiring board according to the present invention includes a conveying unit that carries the flexible printed wiring board at a predetermined speed, and the imaging unit is a line sensor that is fixed at a position and is capable of imaging an entire width of the flexible printed wiring board, and that successively images a wiring pattern image of the inspection part of the flexible printed wiring board being carried at a predetermined speed such that the inspection part successively changes.

In the inspection apparatus for a flexible printed wiring board according to the present invention, the light source is a light source that emits reddish illumination light.

The inspection apparatus for a flexible printed wiring board according to the present invention, further includes an auxiliary light source that emits feeble scattered light onto the inspection part of the front surface of the flexible printed wiring board in addition to the illumination light.

In the inspection apparatus for a flexible printed wiring board according to the present invention, the flexible printed wiring board is a film carrier tape for mounting an electronic part.

In the inspection apparatus for a flexible printed wiring board according to the present invention, the flexible printed wiring board is a COF tape in which the wiring pattern is directly formed on the light permeable insulating film.

### EFFECTS OF THE INVENTION

According to a wiring pattern inspection method and an inspection apparatus for a flexible printed wiring board of the present invention, by emitting illumination light from a front surface side of the flexible printed wiring board while providing a reflection member whose surface is mirrored on a rear surface side, light transmitted at a light permeable insulating film part having no wiring pattern is reflected at a reflection member, and returns to the front surface side after transmitted through the light permeable insulating film as indirect transmission light. Accordingly, by emitting the illumination light from the front surface side of the flexible printed wiring board while providing the reflection member on the rear surface side of the flexible printed wiring board such that a reflection method becomes main and a transmission method becomes subordinate, and imaging a wiring pattern image of an inspection part on the front surface side, it becomes possible to determine the quality of a wiring pattern taking advantage of the reflection method. Further, by utilizing the indirect transmission light, defects of a short-circuiting type on the light permeable insulating film that are difficult to be detected with the reflection method can be detected simultaneously as darker defects than a base part of the light permeable insulating film, thus providing a bias effect. It becomes possible to detect the quality of a wiring pattern with a simple structure, without increasing the measurement time, without increasing the size and the cost of an inspection apparatus, and without requiring a transmission light source.

According to the wiring pattern inspection method and the inspection apparatus according to the present invention, by using a drum whose surface is mirrored as the reflection member, a wiring pattern image can be imaged by an imaging unit without defocus at an inspection part, and a favorable inspection becomes possible.

According to the wiring pattern inspection method and the inspection apparatus according to the present invention, by using a line sensor as the imaging unit, it becomes possible to perform inspection by imaging successively an inspection part while carrying the flexible printed wiring board successively at a predetermined speed without temporarily stopping the flexible printed wiring board, and the measurement tact can be improved.

According to the wiring pattern inspection method and the inspection apparatus according to the present invention, by using reddish illumination having a good transmittance through the light permeable insulating film, a sufficient light amount for providing a bias effect can be obtained as indirect transmission light reflected from the reflection member, and it becomes possible to make defects of a short-circuiting type on the light permeable insulating film noticeable as dark defects.

### BRIEF DESCRIPTION OF THE DRAWINGS

FIG. 1 is a schematic front view of a structure of a wiring pattern inspection apparatus for performing a wiring pattern inspection method for a film carrier tape for mounting an electronic part according to an embodiment.

FIG. 2 is a front view of an enlarged part of a pattern detecting device.

FIG. 3 is a schematic block diagram of a structure example of a control device.

FIGS. 4A to 4C are conceptual diagrams of a luminance profile of a wiring pattern image imaged by a CCD line sensor according to a wiring pattern having normality/abnormality.

FIG. 5 is a graph of characteristics of transmittance/reflectance characteristics of a lead part/base part according to wavelength.

### EXPLANATION OF LETTERS OR NUMERALS

32 drum
33 conveying unit
34 light source
35 CCD line sensor
37 auxiliary light source
60 light permeable insulating film
61 wiring pattern
75 determining unit
T TAB tape
D inspection part

### BEST MODE(S) FOR CARRYING OUT INVENTION

Taking a film carrier tape for mounting an electronic part as an example of a flexible printed wiring board, a wiring pattern inspection method and an inspection apparatus for the film carrier tape for mounting an electronic part as one of the best modes for carrying out the present invention will be explained with reference to the drawings. Note that the drawings show exaggerated frame formats, and the relationship between the thickness and the width of each part is different from the actual one. The present invention is not limited to the embodiments, and can be modified variously insofar as not deviating from the gist of the present invention.

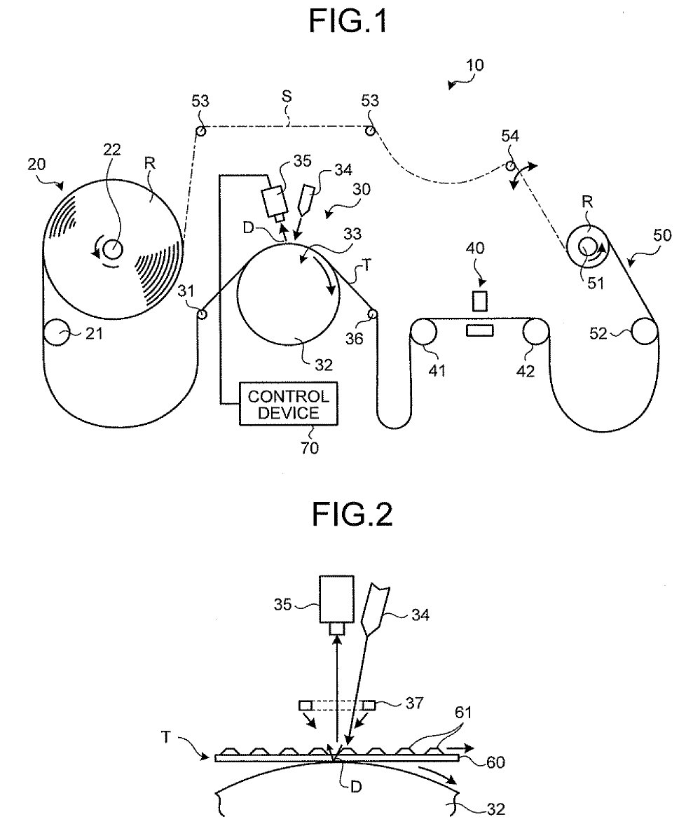

FIG. 1 is a schematic front view of a structure of a wiring pattern inspection apparatus for performing a wiring pattern inspection method for a film carrier tape for mounting an electronic part according to an embodiment. FIG. 2 is a front view of an enlarged part of a pattern detecting device. A wiring pattern inspection apparatus 10 according to the present embodiment has a feeder 20, a pattern detecting device 30, a marker 40, and a reeler 50.

In the feeder 20, for example as shown in FIG. 2, a reel R, to which a TAB tape T is reeled through a spacer S, is mounted on a feeding driving shaft 22. The TAB tape T is a TAB tape (film carrier tape for mounting an electronic part) of a type as a COF tape that has a wiring pattern 61 directly formed on a light permeable insulating film 60, and that has the formed wiring pattern but is still being manufactured, or that has undergone the manufacturing process. By rotating the feeding driving shaft 22 by driving a driving motor (not shown), the TAB tape T is unreeled from the reel R with the spacer S, and is supplied to the pattern detecting device 30 through a guide roller 21 while being loosened to a predetermined degree.

The pattern detecting device 30 has a conveying unit 33 configured with a drum 32 having a large diameter and a gear structure at its both ends that carries the TAB tape T at a predetermined speed while engaging sprocket holes on the both sides of the TAB tape T supplied through a guide roller 31 from the feeder 20, and is rotation-driven by a driving motor (not shown). As shown in FIG. 2, the TAB tape T is carried with its front surface that has the wiring pattern 61 formed on the light permeable insulating film 60 facing above, and the rear surface closely contacting the surface of the drum 32, and in the present embodiment, the drum 32 functions as a reflection member. Accordingly, the drum 32 is the one made of metal, plastic, or the like whose surface is mirrored to have high reflectance.

The pattern detecting device 30 has a light source 34 that emits illumination light onto an inspection part D of the TAB tape T carried by the conveying unit 33 from the front surface (upper side) as non-scattered incident light (high-angle light or coaxial light), a CCD line sensor 35 as the imaging unit that images a wiring pattern image obtained from the inspection part D on the front surface side of the TAB tape T, and a control device 70 that performs quality determination processing or the like of the wiring pattern 61 based on the wiring pattern image imaged by the CCD line sensor 35.

The pattern detecting device 30 inspects the quality of the wiring pattern 61 by combined use of reflection light as main light and transmission light as subordinate light. Illumination light from the light source 34 is emitted from the front surface side of the TAB tape T while disposing the drum 32 on the rear surface side. In this way, light transmitted through the light permeable insulating film 60 where the wiring pattern 61 is not present is reflected by the drum 32 to become indirect transmission light to return to the front surface side through the light permeable insulating film 60, and thus the indirect transmission light is used as the transmission light. Accordingly, the CCD line sensor 35 images a wiring pattern image formed by overlapping the reflection light and the indirect transmission light obtained from the inspection part D. The CCD line sensor 35 is a line sensor that is structured for example by 8000 pixels/line, capable of imaging the entire width of the TAB tape T, and fixed at a position. The width of the tape is equal to or less than 300 millimeters, and preferably equal to or less than 200 millimeters.

Characteristics of the TAB tape T used in the present embodiment will be explained. In the TAB tape T of the present embodiment, the light permeable insulating film 60 is desirably approximately 12.5 micrometers to 100 micrometers thick, preferably 25 micrometers to 50 micrometers thick, because although reflection light is used as main light, indirect transmission light is also used for inspection. With the light permeable insulating film 60 with such a thickness, the luminance or the transmission light transmitted through the light permeable insulating film 60 becomes within the range that the CCD line sensor 35 can perform voltage conversion process. Because the light permeable insulating film 60 contacts acid or the like when being etched, it has chemical resistance and heat resistance such that it is not affected by such a chemical and modified by heat at the time of adhesion. Exemplary materials that form the light permeable insulating film 60 include polyester, polyamide, and polyimide. Particularly, a film made of polyimide is preferably used in the present embodiment. Polyimide that can be used as the light permeable insulating film 60 in the present embodiment generally includes wholly aromatic polyimide synthesized by pyromellitic acid dianhydride and aromatic diamine, and wholly aromatic polyimide synthesized by biphenyl tetracarboxylic acid dianhydride and aromatic diamine. Either of them can be used in the present embodiment. Such polyimide has excellent heat resistance and chemical resistance as compared with other resins.

The polyimide film used as the light permeable insulating film 60 for COF tape is preferably thinner than that used in a usual film carrier, and the average thickness of the light permeable insulating film 60 is usually 12.5 micrometers to 100 micrometers, preferably 25 micrometers to 50 micrometers, and particularly preferably 25 micrometers to 45 micrometers.

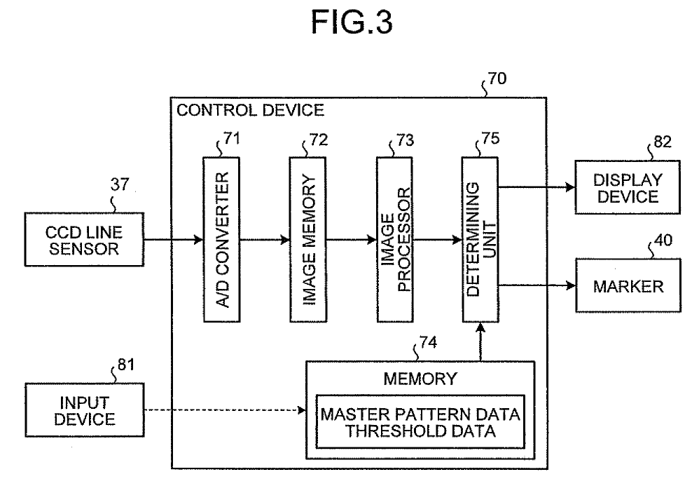

FIG. 3 is a schematic block diagram of a structure example of the control device 70. The control device 70 has an analog to digital (A/D) converter 71, an image memory 72, an image processor 73, a memory 74, and a determining unit 75. The A/D converter 71 digitizes luminance information of the wiring pattern image imaged by the CCD line sensor 35. The image memory 72 temporarily stores therein the luminance information of the wiring pattern digitized by the A/D converter 71. The image processor 73 performs image processing including obtaining gray image data based on the luminance information. The memory 74 stores therein master pattern data and predetermined threshold data (THH, THL) based on a normal wiring pattern received from an input device 81 or the like. The determining unit 75 determines the quality of the gray image data of the wiring pattern image obtained from the inspection part D by referring to the master pattern data and the predetermined threshold data (THH, THL) stored in the memory 74, and outputs the determination result appropriately to the marker 40 of the later stage, or a display device 82 such as a cathode-ray tube (CRT).

When the pattern detecting device 30 detects defects of the wiring pattern 61, the marker 40 marks defect parts of the TAB tape T supplied through the guide rollers 36 and 41 with ink, punching, or the like while the tape is carried between the guide rollers 41 and 42, based on detection information of the defect parts.

The reeler 50 reels the TAB tape T with a predetermined degree of loosening to the reel R mounted on a reeler driving shaft 51 through a guide roller 52 according to the rotation of the reeler driving shaft 51 by the driving of a driving motor (not shown). At this time, the spacer S unreeled from the reel R of the feeder 20 is supplied to the reel R of the reeler 50 through a guide roller 53 and a tension roller 54. By reeling the spacer S to be interposed between portions of the TAB tape T, the TAB tape T is protected so as not contact each other, preventing the ink from attaching to other parts.

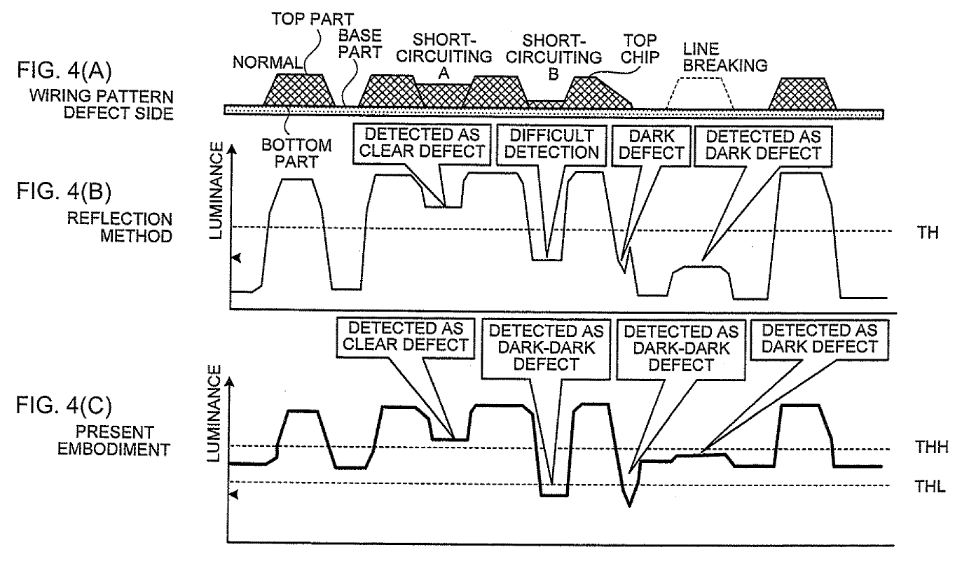

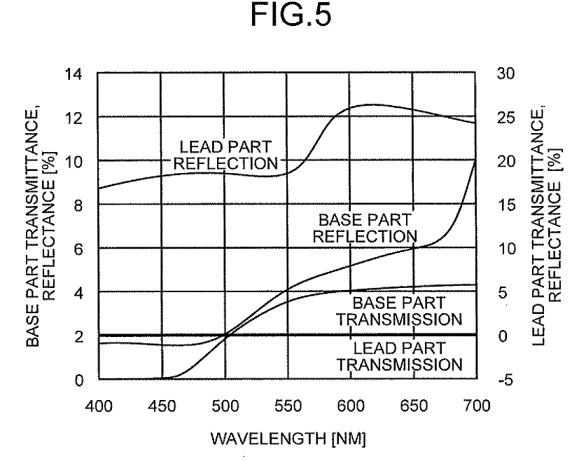

The detecting method for determining the quality of the wiring pattern 61 of the pattern detecting device 30 according to the present embodiment will be explained in comparison with the conventional reflection method. FIGS. 4A to 4C are conceptual diagrams of a luminance profile of a wiring pattern image imaged by a CCD line sensor according to a wiring pattern having normality/abnormality. In the TAB tape T, an apex part having narrow width of the wiring pattern 61 formed as a lead part by the etching processing is a top part, a bottom part having wide width is a bottom part, and a part where only the light permeable insulating film 60 is present around the wiring pattern 61 is a base part. Examples of defects of the wiring pattern 61 generated in the TAB tape T are assumed to be short-circuiting, top notch, and line disconnection. Regarding short-circuiting, in the present embodiment, a short-circuiting generated between the top parts when the thickness of the copper layer of the short-circuiting portion become substantially the same as the thickness of the wiring pattern 61 because the short-circuiting state of the photoresist remains until the end of the etching is called “short-circuiting A”. A short-circuiting generated when the copper layer of the short-circuiting portion is etched in the depth direction and is connected on the base part because for example the short-circuiting state of the photoresist is peeled during the etching is called “short-circuiting B”, which is distinguished from the short-circuiting A. The short-circuiting B includes the one in which the layer is not connected on the base part, but short-circuiting is possibly generated. This is because, in the case of the TAB tape T or the like, it may be bent to be folded in an actual use, and short-circuiting may occur in such an actual use.

In the reflection method shown in FIG. 4B, because a state in which the illumination light emitted from the front surface side of the TAB tape is reflected at the top part of the wiring pattern is imaged and observed, by applying a predetermined threshold TH to the information of the luminance of the wiring pattern image obtained by imaging by the CCD line sensor, a dark defect can be detected when the reflection amount becomes equal to or less than the threshold TH at the top notch part and the top width decreases, and a clear defect can be detected because the short-circuiting A generates a reflection amount equivalent to that of the top part at the short-circuiting A portion and the reflection amount becomes equal to or more than the threshold TH. The line disconnection can be detected as a dark defect because the reflection amount becomes equivalent to that of the base part at the line disconnection part, and the reflection amount becomes equal to or less than the threshold TH. However, in the case of the short-circuiting B, the reflection amount does not reach the threshold TH although there is reflection equivalent to that of the base part or slight reflection, and the reflection amount becomes equal to or less than the threshold TH, and is regarded as being equivalent to that of the base part; therefore, detection is difficult.

On the other hand, in the detection method of the present embodiment shown in FIG. 4C, the reflection light is used as the main light, the transmission light is used as the subordinate light, and the reflection light and the transmission light are used simultaneously to inspect the quality of the wiring pattern 61. Illumination light from the light source 34 is emitted from the front surface side of the TAB tape T by disposing on the rear surface side the drum 32 made of metal, plastic, or the like whose surface is mirrored. In this way, light transmitted through the light permeable insulating film 60 where the wiring pattern 61 is not present is reflected by the drum 32 to become indirect transmission light to return to the front surface side through the light permeable insulating film 60, and thus the indirect transmission light is used as the transmission light. Accordingly, by applying a predetermined threshold THH to the information of the luminance of the wiring pattern image formed by overlapping the reflection light and the indirect transmission light obtained by imaging by the CCD line sensor 35, it is possible to determine the quality of the short-circuiting A or the line disconnection similarly to the reflection method.

Regarding short-circuiting defects such as the short-circuiting B that is difficult to be detected by the reflection method, because there is a luminance difference in indirect transmission light with the base part in a normal case in which there is no short-circuiting defects, by applying the predetermined threshold THL set separately from the threshold THH and trinarized to the luminance information of the wiring pattern image, imaged by the CCD line sensor 35 and formed by overlapping the reflection light and the indirect transmission light, the short-circuiting defects such as the short-circuiting B can be detected as dark-dark defects with equal to or less than the threshold THL. That is, when illumination light is emitted in the absence of the drum 32 whose surface is mirrored on the rear surface side of the TAB tape T (usually, black background), indirect transmission light is not generated, and the base part and the short-circuiting B portion have similar or equivalent dark luminance levels (black levels) and cannot be distinguished clearly from each other. However, a white drum or a mirror having a high reflectance is provided as the drum 32 having a high reflectance on the rear surface side of the TAB tape T, and the normal base part is made bright to have a luminance level of a grey level by sufficient indirect transmission light. Further, when there are defects such as the short-circuiting B on the base part, the illumination light is scattered at a textured copper layer portion of the short-circuiting B having a low reflectance and the indirect transmission light reflected from the drum 32 decreases. Therefore, the short-circuiting B portion is made noticeable as a portion darker than the base part (black level).

In the present embodiment, the top notch defect has a luminance lower than the base part because the luminance is a reflection luminance at the textured copper layer portion having a lower reflectance due to the defect property. By applying the predetermined threshold THL, the top notch defect can be detected as a dark-dark defect with equal to or lower than the threshold THL. By applying the predetermined THH similarly to the conventional reflection method, the top notch may be detected by narrower line width of the wiring pattern 61 portion.

In the detection operation, the drum 32 whose surface is mirrored is used as the reflection member, and the TAB tape T is in close contact with the drum 32 at any time; therefore, the CCD line sensor 35 can image the wiring pattern image of the inspection part D without defocus at any time, and a favorable quality inspection is possible.

Accordingly, according to the present embodiment, the defect inspection of all the wiring pattern 61 can be performed simultaneously, and thus it becomes possible to detect the quality of the wiring pattern 61 appropriately without increasing the measurement time, and without increasing the size and the cost of the inspection apparatus. In particular, because the indirect transmission light reflected from the drum 32 whose surface is mirrored is utilized as transmission light, a simple structure without necessitating a transmission light source can be realized. Accordingly, the CCD line sensor 35 can successively image the wiring pattern image of the inspection part D while changing the inspection part D successively by carrying the TAB tape T at a predetermined speed by the conveying unit 33 without temporarily stopping the TAB tape T, and the measurement tact can be improved.

In the present embodiment, regarding short-circuiting defects, it becomes difficult to detect an intermediate defect between the short-circuiting A type and the short-circuiting B type because the obtained luminance characteristics are largely different between the defects of the short-circuiting A type and the defects of the short-circuiting B type. However, most of the short-circuiting defects, including those that may be short-circuiting, are of the short-circuiting B type; therefore, the present embodiment provides a significant benefit that the short-circuiting B type defects that are difficult to be detected with the reflection method can be surely detected. This is partly due to the fact that the short-circuiting A type defects can be surely detected with an electrical inspector, even if it is difficult to detect them, and the short-circuiting B type defects sometimes cannot be detected with an electrical inspector.

Transmittance/reflectance characteristics of the lead part of the TAB tape T in which the wiring pattern 61 is formed and the base part (the light permeable insulating film 60) located between the lead parts according to a wavelength of visible light are inspected. FIG. 5 is a graph of characteristics of the transmittance/reflectance characteristics of the lead part/the base part according to wavelength. Because the lead part is covered basically with a copper layer, the transmittance thereof is almost 0% irrespective of the wavelength. The reflectance of the lead part is larger in reddish illumination light having a longer wavelength than in bluish illumination light having a shorter wavelength, but the difference is small. On the contrary, such characteristics are found that the transmittance of the base part of the light permeable insulating film 60 is larger in reddish illumination light having a longer wavelength than in bluish illumination light having a shorter wavelength, and that the reflectance of the base part is smaller in bluish illumination light having a shorter wavelength than in illumination light having a longer wavelength.

The characteristic required for illumination light from the light source 34 of the pattern detecting device 30 is that the transmittance at the base part is good because the luminance level of the base part is raised to the grey level utilizing a mirror or the drum 32 whose surface is mirrored. Accordingly, the light source 34 is desirably a light source that emits reddish illumination light having a wavelength of equal to or longer than 550 micrometers.

When reddish illumination light is used as the light source 34 in this way, the luminance of the indirect transmission light at the base part utilizing the drum 32 whose surface is mirrored can be improved, and the short-circuiting type defect such as the short-circuiting B can be made more noticeable as a dark defect, as compared with the case in which white light is used as the illumination light.

The light source 34 may be a light source that emits white illumination light, and the imaging unit that performs imaging with white synthesized light of reflection light obtained from the inspection part D of the TAB tape T and the indirect transmission light may have a reddish filter that separates reddish components from the white synthesized light, and may image the wiring pattern image separated by the reddish filter. If it does not become a trouble in the setting of the three-valued thresholds THH and THL, white light may be used from the illumination up to the imaging.

The light source 34 may be a light source that emits illumination light as incident light (high-angle light or coaxial light) onto the inspection part D. However, when the surface coarseness (surface irregularity) of the top part of the wiring pattern 61 is significant (ideally, in a mirrored state), and there is over-detection attributed to the dispersion of the luminance of the top part itself in detecting the top notch part as a dark defect using the threshold THL, feeble scattered light is given on the inspection part in a 360-degree ring shape by interposing an auxiliary light source 37 as shown in FIG. 2, in addition to illumination light from the light source 35, whereby the influence of the irregularity of the top part surface can be averaged.

In the present invention, a film carrier tape (COF tape) is exemplified in which the light permeable insulating film does not have a device hole, and which is formed with a two-layer CCL in which the conductive metal wiring pattern 61 is arranged directly on the light permeable insulating film 60 without interposing an adhesive layer therebetween. However, the present invention can be applied to a film carrier tape for mounting an electronic part manufactured using a three-layer CCL in which conductive metal foil is adhered onto the light permeable insulating film through an adhesive layer. Moreover, the present invention can be applied to a FPC which is a sheet-like flexible printed wiring board.

### INDUSTRIAL APPLICABILITY

As described above, the wiring pattern inspection method and the inspection apparatus for the flexible printed wiring board of the present invention are useful for detection of short-circuiting type defects of the wiring pattern and defects on the front surface side, and in particular is suitable for determination of the quality of a film carrier tape for mounting an electronic part.

1. A wiring pattern inspection method for a flexible printed wiring board, which inspects a quality of a wiring pattern formed on a front surface of a light permeable insulating film, the wiring pattern inspection method comprising:
irradiating with illumination light an inspection part of the flexible printed wiring board from the front surface in a state where a reflection member whose surface is mirrored is disposed on a rear surface of the flexible printed wiring board;
imaging a wiring pattern image formed by overlapping reflection light obtained from the inspection part on the front surface of the flexible printed wiring board, and indirect transmission light transmitted through the light permeable insulating film, reflected from the reflection member, and transmitted again through the light permeable insulating film; and
examining the quality of the wiring pattern based on a wiring pattern image imaged by the imaging unit and formed by overlapping the reflection light and the indirect transmission light.

2. The wiring pattern inspection method for a flexible printed wiring board according to claim 1, wherein the reflection member is a drum whose surface is mirrored.

3. The wiring pattern inspection method for a flexible printed wiring board according to claim 1, wherein
the imaging unit is a line sensor that is fixed at a position and is capable of imaging an entire width of the flexible printed wiring board, and
the line sensor images a wiring pattern image of the inspection part successively while the inspection part is successively changed by carrying the flexible printed wiring board at a predetermined speed.

4. The wiring pattern inspection method for a flexible printed wiring board according to claim 1, wherein reddish illumination light is applied onto the flexible printed wiring board.

5. The wiring pattern inspection method for a flexible printed wiring board according to claim 1, wherein feeble scattered light is applied onto the inspection part of the front surface of the flexible printed wiring board in addition to the illumination light.

6. The wiring pattern inspection method for a flexible printed wiring board according to claim 1, wherein the flexible printed wiring board is a film carrier tape for mounting an electronic part.

7. The wiring pattern inspection method for a flexible printed wiring board according to claim 1, wherein the flexible printed wiring board is a chip on film (COF) tape in which the wiring pattern is directly formed on the light permeable insulating film.

8. An inspection apparatus for a flexible printed wiring board, which inspects a quality of a wiring pattern formed on a front surface of a light permeable insulating film, the inspection apparatus comprising:
a reflection member whose surface is mirrored and which is disposed on a rear surface of the flexible printed wiring board;
a light source that emits with illumination light an inspection part of the flexible printed wiring board from the front surface;
an imaging unit that images a wiring pattern image formed by overlapping reflection light obtained from the inspection part on the front surface of the flexible printed wiring board, and indirect transmission light transmitted through the light permeable insulating film, reflected from the reflection member, and transmitted again through the light permeable insulating film; and
a determining unit that determines the quality of the wiring pattern based on a wiring pattern image imaged by the imaging unit and formed by overlapping the reflection light and the indirect transmission light.

9. The inspection apparatus for a flexible printed wiring board according to claim 8, wherein the reflection member is a drum whose surface is mirrored.

10. The inspection apparatus for a flexible printed wiring board according to claim 8, further comprising a conveying unit that carries the flexible printed wiring board at a predetermined speed, wherein
the imaging unit is a line sensor that is fixed at a position and is capable of imaging an entire width of the flexible printed wiring board, and that successively images a wiring pattern image of the inspection part of the flexible printed wiring board being carried at a predetermined speed such that the inspection part successively changes.

11. The inspection apparatus for a flexible printed wiring board according to claim 8, wherein the light source is a light source that emits reddish illumination light.

12. The inspection apparatus for a flexible printed wiring board according to claim 8, further comprising an auxiliary light source that emits feeble scattered light onto the inspection part on the front surface of the flexible printed wiring board in addition to the illumination light.

13. The inspection apparatus for a flexible printed wiring board according to claim 8, wherein the flexible printed wiring board is a film carrier tape for mounting an electronic part.

14. The inspection apparatus for a flexible printed wiring board according to claim 8, wherein the flexible printed wiring board is a COF tape in which the wiring pattern is directly formed on the light permeable insulating film.
